(19) United States
(12) Patent Application Publication
(10) Pub. No.: US 2024/0170795 A1
(43) Pub. Date: May 23, 2024

(54) BATTERY STORAGE DEVICE

(71) Applicant: HONDA MOTOR CO., LTD., Tokyo (JP)

(72) Inventors: Takuya MATSUMOTO, Saitama (JP); Kei WATANABE, Saitama (JP)

(73) Assignee: HONDA MOTOR CO., LTD., Tokyo (JP)

(21) Appl. No.: 18/283,398

(22) PCT Filed: Mar. 25, 2021
(86) PCT No.: PCT/JP2021/012727

§ 371 Date: Sep. 21, 2023

(51) Int. Cl. H01M 50/296; H01M 50/209; H01M 50/271; H01M 50/574

(52) U.S. Cl. CPC H01M 50/296; H01M 50/209; H01M 50/271; H01M 50/574; H01M 2220/20

(57) ABSTRACT

This battery storage device includes: a body unit which includes a battery storage portion provided with an insertion/removal opening; an opening/closing unit which opens/closes the insertion/removal opening; and an input terminal pin, wherein a battery is stored in the battery storage portion so as to be insertable/removable through the insertion/removal opening. The input terminal pin is displaceably provided. The battery storage device further includes a connection terminal displacement mechanism which displaces the input terminal pin. The connection terminal displacement mechanism displaces the input terminal pin in conjunction with the opening/closing operation of the opening/closing unit.

### TECHNICAL FIELD

The present invention relates to a battery storage device.

### BACKGROUND ART

In the related art, a vehicle, a construction machine, a working machine, and the like using an internal combustion engine as a drive source have been known, but in recent years, from the viewpoint of global environmental protection, electrification of the drive source is progressing rapidly as an effort to realize a low-carbon society. For example, Patent Literature 1 discloses an electric motorcycle in which a battery is detachably mounted and which is driven by electric power stored in a battery.

The motorcycle described in Patent Literature 1 includes a battery storage device that detachably accommodates the battery. The battery storage device mounted on the motorcycle disclosed in Patent Literature 1 includes a lock mechanism capable of fixing and holding the battery to a battery case, a case-side connection terminal connected to a battery-side connection terminal provided on the battery, and an operation lever. Further, the battery storage device mounted on the motorcycle described in Patent Literature 1 switches the lock mechanism between a battery fixed state and a battery non-fixed state by operating the operation lever, and switches the case-side connection terminal between a connected state and a disconnected state with respect to the battery-side connection terminal CITATION LIST

### PATENT LITERATURE

Patent Literature 1: WO2019/064593A1

### SUMMARY OF INVENTION

### Technical Problem

However, the battery storage device in Patent Literature 1 includes the operation lever that displaces the case-side connection terminal, and there is a problem that the number of components increases. Further, in the battery storage device in Patent Literature 1, it is necessary to connect the case-side connection terminal to the battery-side terminal by operating the operation lever, and it is necessary to operate the operation lever to connect the case-side connection terminal to the battery-side terminal apart from an operation of closing a passenger seat, which increases operation man-hours.

The present invention provides a battery storage device that does not require a member such as a lever that displaces a case-side connection terminal, and can reduce operation man-hours for connecting the case-side connection terminal to a battery-side terminal.

### Solution to Problem

The present invention provides a battery storage device including:
a body including a battery accommodating portion provided with an insertion and removal opening opened in a first direction;
an opening and closing portion provided in a manner of being openable and closable with respect to the body so as to open and close the insertion and removal opening; and
a case-side connection terminal, in which
a battery including a battery-side connection terminal is accommodated so as to be insertable and removal in the battery accommodating portion through the insertion and removal opening,
the case-side connection terminal is provided in a manner of being displaceable between a connection position where the case-side connection terminal is connected to the battery-side connection terminal and a retreat position where the case-side connection terminal is separated from the battery-side connection terminal,
the battery storage device further includes a connection terminal displacement mechanism configured to displace the case-side connection terminal between the connection position and the retreat position, and
the connection terminal displacement mechanism displaces the case-side connection terminal in conjunction with an opening and closing operation of the opening and closing portion.

### Advantageous Effects of Invention

According to the present invention, since a case-side connection terminal can be displaced between a connection position and a retreat position in conjunction with an opening and closing operation of an opening and closing portion, a member such as a lever or a handle that displaces the case-side connection terminal between the connection position and the retreat position becomes unnecessary. Accordingly, the number of components of the battery storage device can be reduced. Furthermore, since the case-side connection terminal is displaced and connected to a battery terminal by the opening and closing operation of the opening and closing portion, it is not necessary to separately perform an operation for connecting the case-side connection terminal to the battery-side terminal, and operation man-hours for connecting the case-side connection terminal to the battery-side terminal can be reduced.

### BRIEF DESCRIPTION OF DRAWINGS

FIG. 1 is a perspective view of a battery storage device according to an embodiment of the present invention as viewed obliquely from a front upper side.

FIG. 2 is a perspective view of the battery storage device in FIG. 1 as viewed obliquely from a rear upper side with a body cover and a top cover removed.

FIG. 3 is a side view of the battery storage device in FIG. 2 as viewed from a left side, and shows a state in which an opening and closing unit is at a fully open position.

FIG. 4 is a side view of the battery storage device in FIG. 2 as viewed from the left side, and shows a state in which the opening and closing unit is at a fully closed position.

FIG. 5 is a rear view of the battery storage device in FIG. 2 as viewed from a rear side.

FIG. 6 is a perspective view of an input plug of the battery storage device in FIG. 1.

FIG. 7 shows side views showing a positional relationship between the opening and closing unit and the input plug in the battery storage device in FIG. 1 as viewed from the left side.

FIG. 8A is a cross-sectional view of a main part of the battery storage device in FIG. 1 when the input plug is at a retreat position.

FIG. 8B is a cross-sectional view of a main part of the battery storage device in FIG. 1 when the input plug is at a fitting start position.

FIG. 8C is a cross-sectional view of a main part of the battery storage device in FIG. 1 when the input plug is at a connection position.

FIG. 8D is a cross-sectional view of a main part of the battery storage device in FIG. 1 when the opening and closing unit is at the fully closed position.

### DESCRIPTION OF EMBODIMENTS

Hereinafter, an embodiment of a battery storage device according to the present invention will be described with reference to the accompanying drawings. The drawings are viewed in directions of reference numerals.

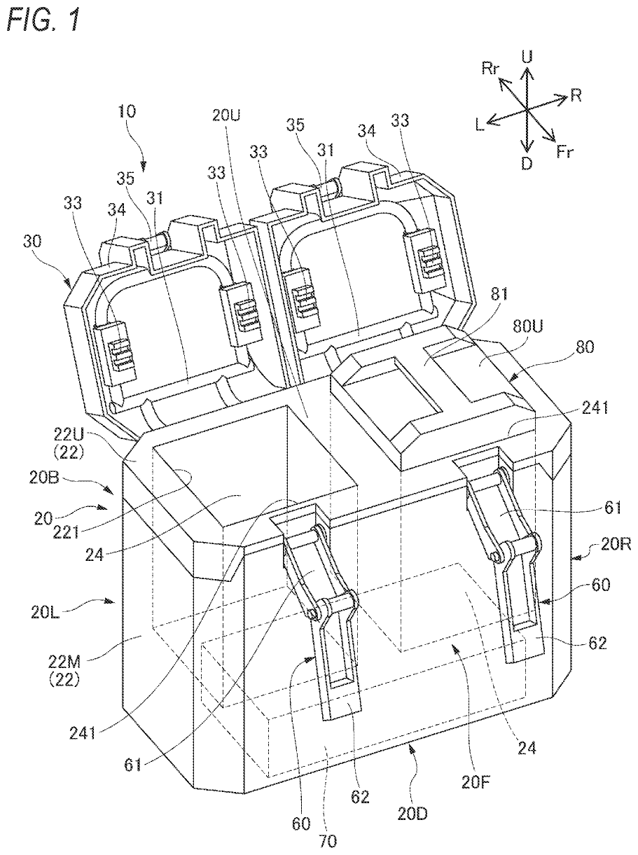

As shown in FIG. 1, a battery storage device 10 detachably accommodates a battery 80. The battery 80 has a substantially quadrangular prism shape elongated in the up-down direction.

In the present specification and the like, in order to simplify and clarify a description, respective directions of front and rear, left and right, and up and down will be described with reference to a state in which a rotation axis direction of an opening and closing unit 30 is a left-right direction, an insertion and removal direction of the battery 80 is an up-down direction, and a direction orthogonal to the rotation axis direction of the opening and closing unit 30 and the insertion and removal direction of the battery 80, that is, a rotating direction of the opening and closing unit 30 as viewed from the up-down direction is a front-rear direction. In the drawings, a front side of the battery storage device 10 is indicated by Fr, a rear side is indicated by Rr, a left side is indicated by L, a right side is indicated by R, an upper side is indicated by U, and a lower side is indicated by D. The front-rear, up-down, and left-right directions defined in this specification are merely defined for convenience, and are irrelevant to front-rear, up-down, and left-right directions of a product on which the battery storage device 10 is mounted. Further, the front-rear, up-down, and left-right directions of the battery storage device 10 in a state in which the battery storage device 10 is mounted on the product may be the same as or different from the above directions.

<Battery>

The battery 80 has the substantially quadrangular prism shape elongated in the up-down direction. A grip portion 81 is provided on an upper surface 80U of the battery 80. The grip portion 81 extends in the front-rear direction substantially at a center of the upper surface 80U in the left-right direction.

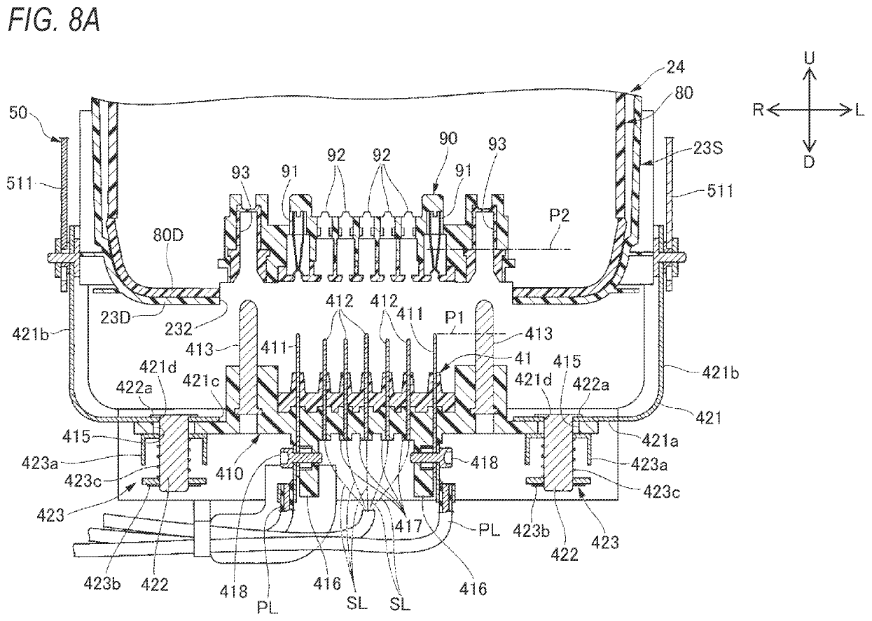

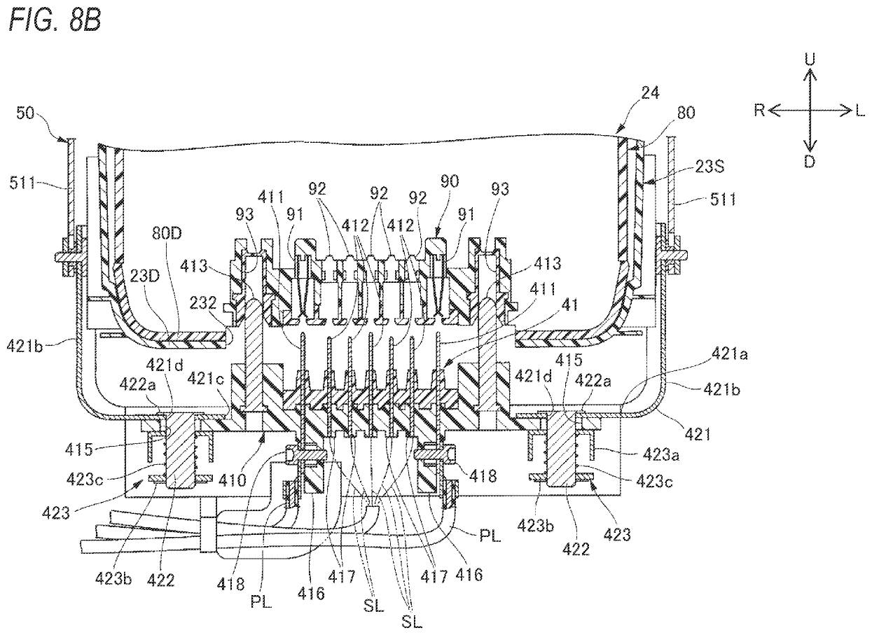

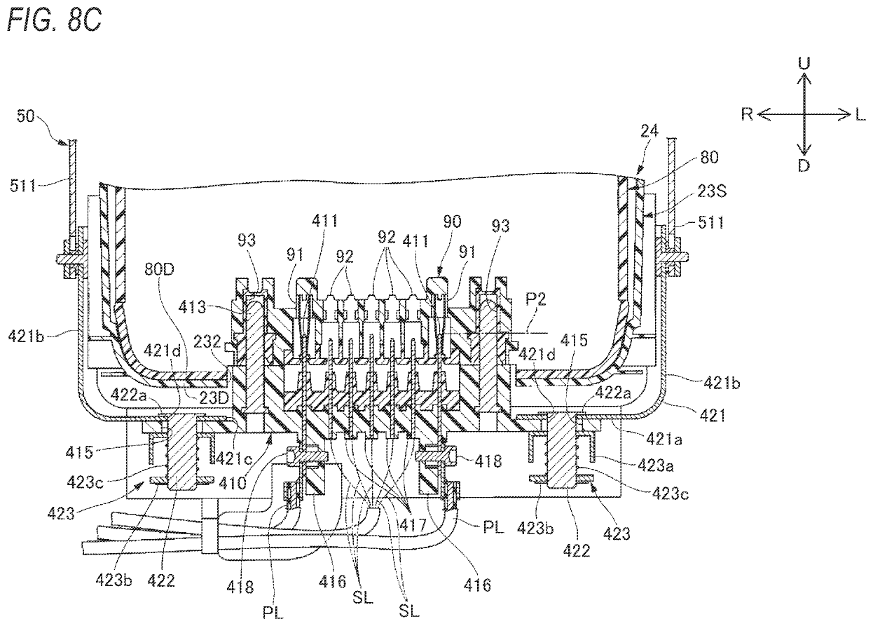

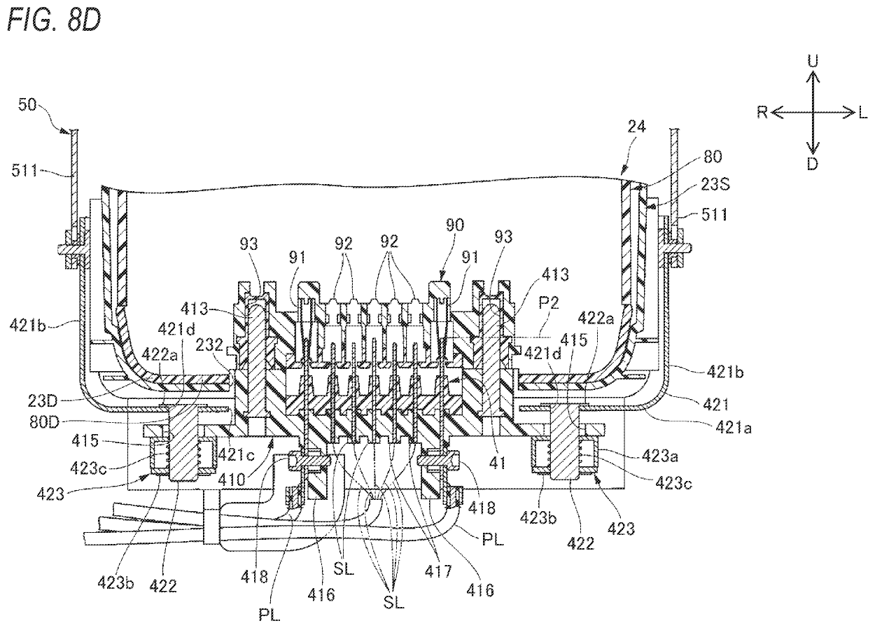

As shown in FIGS. 8A to 8D, a battery-side connection terminal unit 90 is provided in the vicinity of a rear end of a bottom surface 80D of the battery 80. The battery-side connection terminal unit 90 is provided in a manner of being recessed upward from the bottom surface 80D of the battery 80 such that a lower end surface thereof is substantially flush with the bottom surface 80D of the battery 80. The battery-side connection terminal unit 90 is provided with a pair of positive and negative output terminal sockets 91 for outputting electric power stored in the battery 80, and a plurality of signal terminal sockets 92 for outputting signals of various kinds of information indicating a state of the battery 80. The plurality of signal terminal sockets 92 are arranged in a line in the left-right direction. The pair of output terminal sockets 91 are respectively provided on a left outer side and a right outer side of the plurality of signal terminal sockets 92 arranged in the line in the left-right direction, and are arranged in a line in the left-right direction together with the plurality of signal terminal sockets 92.

The battery-side connection terminal unit 90 further includes a pair of left and right guide holes 93 recessed upward. The pair of left and right guide holes 93 are respectively provided on the left outer side of the output terminal socket 91 disposed on the left side and the right outer side of the output terminal socket 91 disposed on the right side.

<Battery Accommodating Device>

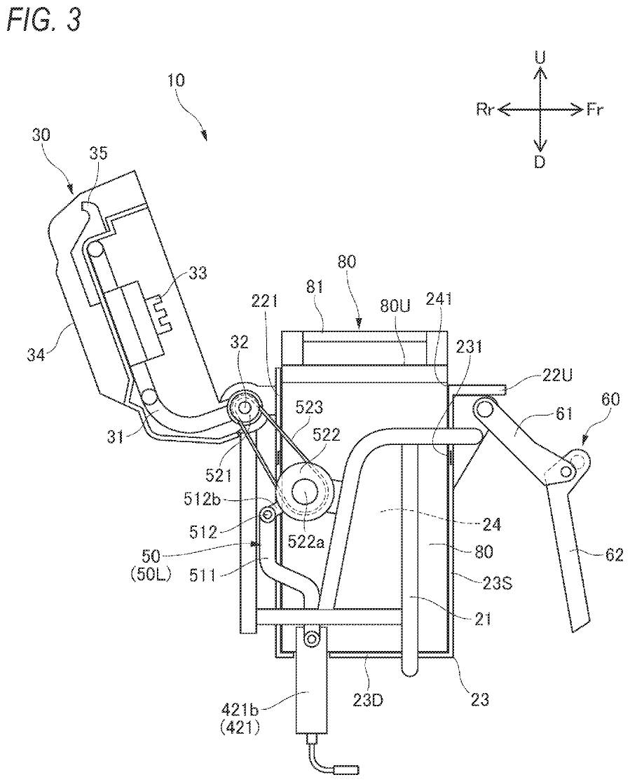

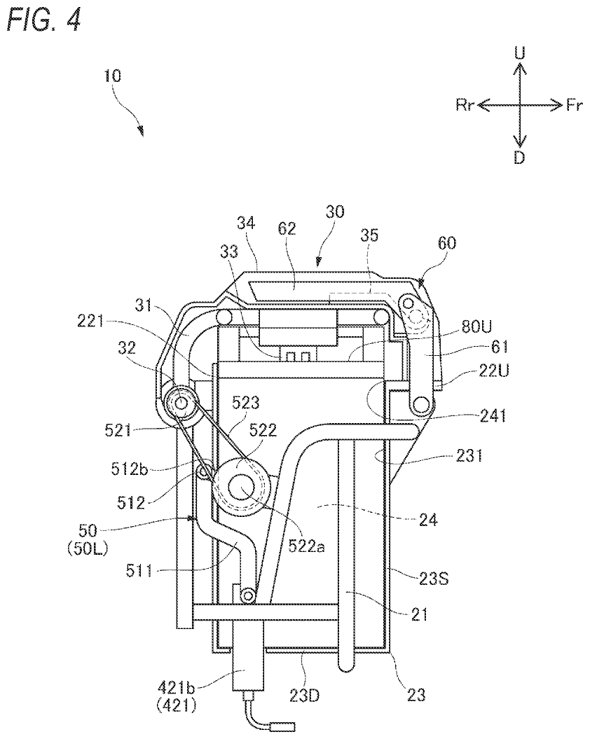

As shown in FIGS. 1 to 4, the battery storage device 10 includes a body unit 20, opening and closing units 30, case-side connection terminal units 40, connection terminal displacement mechanisms 50, and buckle units 60. FIG. 3 is a view showing the opening and closing unit 30 at a fully open position, and FIG. 4 is a view showing the opening and closing unit 30 at a fully closed position.

(Body Unit)

The body unit 20 has a substantially quadrangular prism shape in which (a dimension in the front-rear direction)<(a dimension in the left-right direction)<(a dimension in the up-down direction). The body unit 20 includes a front surface 20F, a rear surface 20B, a left surface 20L, a right surface 20R, an upper surface 20U, and a bottom surface 20D.

The body unit 20 includes a main body frame 21 constituting a skeleton portion of the body unit 20, a body cover 22 constituting an outer shell of the body unit 20, and battery accommodating cases 23 in which the battery 80 is detachably accommodated. In the present embodiment, the body unit 20 includes two battery accommodating cases 23 arranged in the left-right direction.

The body cover 22 forms the front surface 20F, the rear surface 20B, the left surface 20L, the right surface 20R, and the bottom surface 20D of the body unit 20, and includes a bottomed square tubular main cover 22M and an upper cover 22U that constitutes the upper surface 20U of the body unit 20. The upper cover 22U and the main cover 22M are locked, and at least one of the main cover 22M and the upper cover 22U is fixed to the main body frame 21. Accordingly, the body cover 22 is fixed to the body frame 21.

The upper cover 22U is provided with an insertion and removal portion 221 having a square tubular shape penetrating in the up-down direction as viewed from above. In the present embodiment, two insertion and removal portions 221 are provided side by side in the left-right direction. The insertion and removal portion 221 is formed in a manner of being fitted into an opening 231 of the battery accommodating case 23 to be described later, and communicates with an inside of the battery accommodating case 23. Further, the battery 80 accommodated in the battery accommodating case 23 is inserted into and removed from the body unit 20 in the up-down direction through the insertion and removal portion 221.

The battery accommodating case 23 has a square tubular shape including a bottom portion elongated in the up-down direction, and includes a side wall 23S and a bottom wall 23D forming the square tubular shape. The battery accommodating case 23 is disposed below the insertion and removal portion 221 provided on the body cover 22 of the body unit 20, is fitted to the insertion and removal portion 221, and is fixed to the main body frame 21. In the present embodiment, the body unit 20 includes two battery accommodating cases 23 disposed below the respective insertion and removal portions 221. An upper surface of the battery accommodating case 23 is an opening 231 that is opened in an upward direction. In the vicinity of a rear end of the bottom wall 23D, an insertion hole 232 penetrating in the up-down direction is provided at a position facing the battery-side connection terminal unit 90 in a state in which the battery 80 is accommodated in the battery accommodating case 23 (see FIGS. 8A to 8D).

In this way, in the body unit 20, a battery accommodating portion 24 that has a substantially square tubular shape including a bottom portion elongated in the up-down direction and that is surrounded by the side wall 23S and the bottom wall 23D of the battery accommodating case 23 and the insertion and removal portion 221 of the body cover 22 fitted to the battery accommodating case 23, is formed. Further, the battery accommodating portion 24 is provided with an insertion and removal opening 241 which is opened upward by the insertion and removal portion 221 having the square tubular shape which is provided in the body cover 22 and penetrates in the up-down direction. The battery 80 is accommodated in the battery accommodating portion 24. Further, the battery 80 can be inserted into and removed from the battery accommodating portion 24 through the insertion and removal opening 241 by moving in the up-down direction. In the present embodiment, the body unit 20 includes two battery accommodating portions 24 arranged in the left-right direction.

The batteries 80 accommodated in the two battery accommodating portions 24 are connected in series by an electric power line (not shown) provided in the battery storage device 10.

An electrical component 70 is accommodated in the bottomed square tubular main cover 22M below the two battery accommodating cases 23. In the present embodiment, the electrical component 70 includes a battery management system (BMS) that monitors a state of the battery 80 accommodated in the battery accommodating portion 24 and controls an output thereof, a DC-DC converter that can increase and decrease a voltage of electric power output from the battery 80 accommodated in the battery accommodating portion 24, a system power supply that has a lower voltage and is smaller than the battery 80 and that drives the battery management system, and the like.

(Opening and Closing Unit)

The opening and closing unit 30 is provided in a manner of being openable and closable with respect to the body unit 20 so as to open and close the insertion and removal opening 241. One opening and closing unit 30 is provided in each battery accommodating portion 24 of the body unit 20. In the present embodiment, in the body unit 20, two battery accommodating portions 24 are provided side by side in the left-right direction, and two opening and closing units 30 are also provided side by side in the left-right direction. Each of the opening and closing units 30 includes a cover frame 31 constituting a skeleton portion of the opening and closing unit 30, a hinge shaft 32, a pressing member 33 fixed to the cover frame 31, and a top cover 34 constituting an outer shell of the opening and closing unit 30.

The hinge shaft 32 extends in the left-right direction behind the battery accommodating portion 24 and in the vicinity of the insertion and removal opening 241 of the battery accommodating portion 24. The hinge shaft 32 is integrally formed with the cover frame 31. The hinge shaft 32 is pivotally supported by the main body frame 21 of the body unit 20. The opening and closing unit 30 is pivotable with respect to the body unit 20 about the hinge shaft 32 that is pivotally supported by the main body frame 21 of the body unit 20 and extends in the left-right direction as a pivot axis. Further, an opening and closing operation of the opening and closing unit 30 is performed by pivoting the opening and closing unit 30 with respect to the body unit 20 about the hinge shaft 32 as the pivot axis. A closing operation of the opening and closing unit 30 is performed by pivoting the opening and closing unit 30 forward, that is, in a clockwise direction as viewed from a leftward direction with respect to the body unit 20 about the hinge shaft 32 as the pivot axis. An opening operation of the opening and closing unit 30 is performed by pivoting the opening and closing unit 30 backward, that is, in a counterclockwise direction as viewed from the leftward direction with respect to the body unit 20 about the hinge shaft 32 as the pivot axis.

The pressing member 33 is formed of an elastic member such as rubber. The pressing member 33 is provided in a manner of pressing the upper surface 80U of the battery 80 downward when the battery 80 is accommodated in the battery accommodating portion 24 and the opening and closing unit 30 is at the fully closed position. Accordingly, when the opening and closing unit 30 is at the fully closed position, the battery 80 accommodated in the battery accommodating portion 24 is pressed downward by the pressing member 33, and thus it is possible to prevent vibration of the battery 80 in the battery accommodating portion 24 during operation of the battery 80, and it is possible to prevent occurrence of a failure of the battery 80 or a connection failure between the battery-side connection terminal unit 90 and the case-side connection terminal unit 40.

The top cover 34 is formed in a manner of covering the cover frame 31, the pressing member 33, and the insertion and removal opening 241 of the battery accommodating portion 24 from above and seal the battery accommodating portion 24 when the opening and closing unit 30 is at the fully closed position. Accordingly, when the opening and closing unit 30 is at the fully closed position, since the insertion and removal opening 241 of the battery accommodating portion 24 is covered by the top cover 34, the battery 80 accommodated in the battery accommodating portion 24 cannot be removed from the battery accommodating portion 24, and it is possible to prevent rain, dust, and the like from entering the battery accommodating portion 24 from an outside.

(Case-Side Connection Terminal Unit)

The case-side connection terminal unit 40 is accommodated in the body unit 20. The case-side connection terminal unit 40 includes an input plug 41 that can be fitted into the battery-side connection terminal unit 90 by being inserted into the insertion hole 232 provided in the bottom wall 23D of the battery accommodating case 23, and a plug holder 42 that holds the input plug 41.

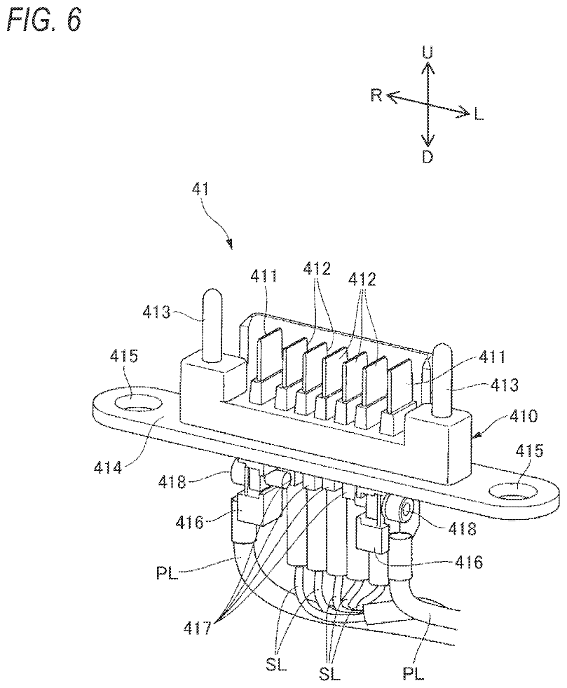

As shown in FIG. 6, the input plug 41 includes a terminal block 410, a pair of positive and negative input terminal pins 411, and the same number of signal terminal pins 412 as the signal terminal sockets 92. The input terminal pins 411 and the signal terminal pins 412 are provided in a manner of protruding upward from the terminal block 410. The plurality of signal terminal pins 412 are arranged side by side in a line in the left-right direction such that the signal terminal pins 412 can be fitted and connected to the facing signal terminal sockets 92, respectively. The pair of input terminal pins 411 are provided on the left outer side and the right outer side of the plurality of signal terminal pins 412 arranged in the line in the left-right direction such that the input terminal pins 411 can be fitted and connected to the facing output terminal sockets 91, respectively, and are arranged in a line in the left-right direction together with the plurality of signal terminal pins 412.

The pair of left and right input terminal pins 411 are electrically connected to the above-described DC-DC converter of the electrical component 70 accommodated in the body unit 20. When the pair of left and right input terminal pins 411 are fitted and connected to the pair of left and right output terminal sockets 91 of the battery-side connection terminal unit 90, the electric power stored in the battery 80 output from the output terminal sockets 91 of the battery-side connection terminal unit 90 passes through the input terminal pins 411, is raised and lowered by the DC-DC converter, and is supplied to an external load.

Each of the signal terminal pins 412 is electrically connected to the above-described battery management system of the electrical component 70 accommodated in the body unit 20. When the signal terminal pins 412 are fitted and connected to the facing signal terminal sockets 92 of the battery-side connection terminal unit 90, respectively, signals of various kinds of information indicating the state of the battery 80 and output from the signal terminal sockets 92 of the battery-side connection terminal unit 90, are input to the battery management system through the signal terminal pins 412. The battery management system controls the battery 80 based on the input signals of various kinds of information indicating the state of the battery 80.

The input plug 41 further includes a pair of left and right guide pins 413 protruding upward from the terminal block 410. The pair of left and right guide pins 413 are provided on the left outer side of the input terminal pin 411 disposed on the left side and the right outer side of the input terminal pin 411 disposed on the right side in a manner of being respectively fittable into the facing guide holes 93. The guide pin 413 has a substantially cylindrical shape, and an upper end thereof has a spherical shape or a tapered shape. Further, in the present embodiment, upper ends of the pair of left and right input terminal pins 411 are higher than upper ends of the signal terminal pins 412. Further, the upper ends of the pair of left and right guide pins 413 are higher than the upper ends of the pair of left and right input terminal pins 411.

The input plug 41 includes a flange 414 protruding from the terminal block 410 to front, rear, left, and right outer sides. The flange 414 is provided in a manner of protruding from a lower end of the terminal block 410 to the front, rear, left, and right outer sides. The flange 414 has an oval shape elongated in the left-right direction, and a length of protrusion from the terminal block 410 is longer in the left-right direction than in the front-rear direction. The flange 414 has a pair of left and right insertion holes 415 formed on both left and right outer sides of the terminal block 410.

The lower end of the terminal block 410 is provided with electric power line connection walls 416 that connect electric power lines PL to the input terminal pins 411 and signal line connection portions 417 that connect signal lines SL to the signal terminal pins 412. The electric power line connection walls 416 are respectively disposed outside the signal line connection portions 417 in the vehicle width direction. Bolts 418 for connecting metal leads of the electric power lines PL to the input terminal pins 411 are fastened to the electric power line connection walls 416 from the outside in the left-right direction. The electric power line PL and the input terminal pin 411 are firmly connected electrically and physically by the bolt 418.

As shown in FIGS. 8A to 8D, the plug holder 42 includes a frame member 421 extending in a substantially U-shape as viewed in the front-rear direction, and coupling pins 422 and spring units 423 that couple the frame member 421 and the input plug 41.

The frame member 421 includes a base 421a extending in the left-right direction below the battery accommodating case 23, and a pair of left and right sides 421b bent upward from both left and right ends of the base 421a and extending in the up-down direction on left and right outer sides of the battery accommodating case 23.

An insertion hole 421c which has a long hole shape elongated in the left-right direction and through which the terminal block 410 of the input plug 41 can be inserted is formed in a central portion of the base 421a in the left-right direction. Further, a pair of left and right support holes 421d are formed on both left and right outer sides of the insertion hole 421c in the base 421a

Each of the coupling pin 422 has a substantially cylindrical shape, and is integrally formed with a retaining flange 422a at an upper end thereof. The coupling pins 422 are inserted from above into the pair of left and right support holes 421d formed in the base 421a. The coupling pins 422 is slidable in the up-down direction with respect to the base 421a, but the retaining flange 422a abuts on an upper surface of the base 421a of the frame member 421, so that the coupling pin 422 does not come off from the support hole 421d.

Each of the spring units 423 includes a unit case 423a which has a bottomed cylindrical shape including an open bottom and has, in an upper bottom wall, an insertion hole through which the coupling pin 422 can be inserted, a circular plate-shaped stopper plate 423b capable of abutting on a lower end of the unit case 423a, and a coil spring 423c as an elastic member interposed between the upper bottom wall of the unit case 423a and the stopper plate 423b. The stopper plate 423b is fixed to a lower end of the coupling pin 422.

The input plug 41 is coupled to the frame member 421 via the coupling pins 422 and the spring units 423.

First, the terminal block 410 of the input plug 41 is inserted into the insertion hole 421c provided in the base 421a of the frame member 421 from below. At this time, the terminal block 410 is inserted from below into the insertion hole 421c provided in the base 421a such that the coupling pins 422 are inserted from above into the pair of left and right insertion holes 415 formed in the flange 414 of the terminal block 410.

Next, the spring unit 423 is attached to each of the coupling pins 422. The coupling pin 422 is attached to the spring unit 423 so as to be inserted through the insertion hole provided in the upper bottom wall of the unit case 423a and an inside of a coil of the coil spring 423c. Further, the stopper plate 423b is fixed to the lower end of the coupling pin 422.

In this manner, the input plug 41 is coupled to the frame member 421 while being biased upward by the coil spring 423c in a state in which the flange 414 is sandwiched between the upper bottom wall of the unit case 423a of the spring unit 423 and the base 421a of the frame member 421.

(Connection Terminal Displacement Mechanism)

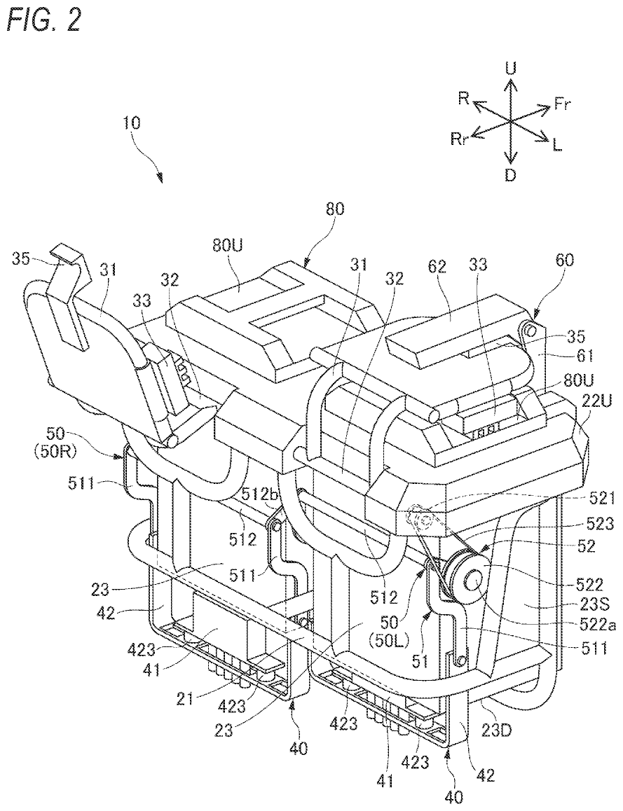

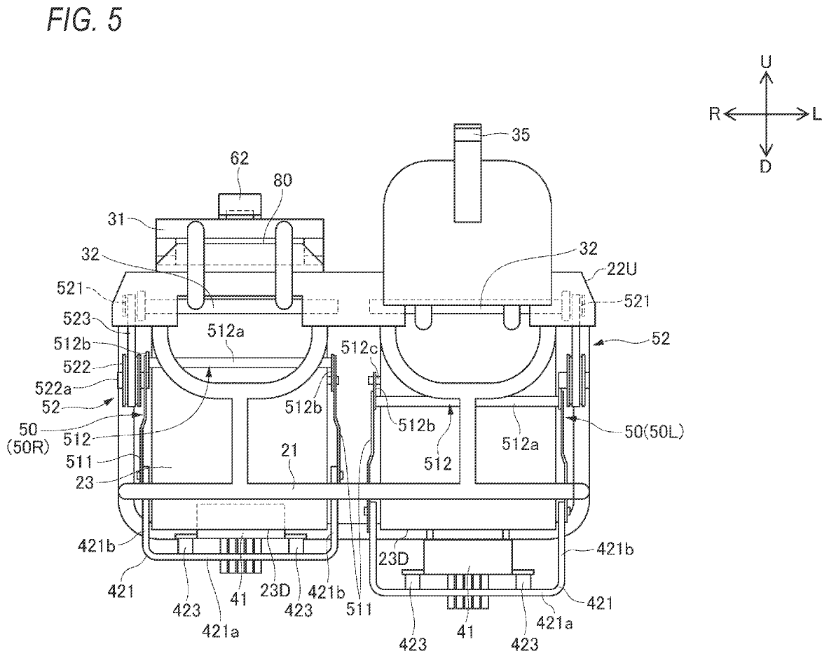

As shown in FIGS. 2 to 5, each of the connection terminal displacement mechanisms 50 includes a link mechanism 51 that displaces the case-side connection terminal unit 40 in the up-down direction, and a deceleration device 52 that decelerates the pivot of the opening and closing unit 30 and transmits the pivot to the link mechanism 51. In the present embodiment, two connection terminal displacement mechanisms 50 are provided. Specifically, in the present embodiment, two case-side connection terminal units 40 are provided side by side in the left-right direction, and the connection terminal displacement mechanism 50 includes a connection terminal displacement mechanism 50L that displaces the left case-side connection terminal unit 40 in the up-down direction and a connection terminal displacement mechanism 50R that displaces the right case-side connection terminal unit 40 in the up-down direction. The connection terminal displacement mechanism 50L and the connection terminal displacement mechanism 50R have a bilaterally symmetrical structure. Hereinafter, when it is not necessary to distinguish between the connection terminal displacement mechanism 50L and the connection terminal displacement mechanism 50R, each is referred to as the connection terminal displacement mechanism 50.

The deceleration device 52 includes a drive pulley 521 that is coupled to the hinge shaft 32 of the opening and closing unit 30 and pivots integrally with the hinge shaft 32, a driven pulley 522 that is coupled to a driven pulley shaft 522a rotatably supported by the main body frame 21 of the body unit 20 and pivots integrally with the driven pulley shaft 522a, and a transmission belt 523 that is wound around the drive pulley 521 and the driven pulley 522.

The drive pulley 521 is coupled to an end of the hinge shaft 32. In the present embodiment, the drive pulley 521 is coupled to an outer end in the left-right direction of the body unit 20 of the hinge shaft 32. Specifically, in the present embodiment, two opening and closing units 30 are provided side by side in the left-right direction, the drive pulley 521 is coupled to a left end of the hinge shaft 32 of the left opening and closing unit 30, and the drive pulley 521 is coupled to a right end of the hinge shaft 32 of the right opening and closing unit 30. Accordingly, the drive pulley 521 can be disposed in a space between the end of the hinge shaft 32 and the body cover 22, thereby preventing the battery storage device 10 from increasing in size.

The driven pulley 522 is a pulley having a larger diameter than the drive pulley 521. Accordingly, the driven pulley 522 is provided below and in front of the drive pulley 521 paired therewith at substantially the same position as the drive pulley 521 in the left-right direction. The driven pulley 522 is provided outside the battery accommodating case 23 in the left-right direction. Specifically, the driven pulley 522 of the left connection terminal displacement mechanism 50 is provided on the left outer side of the left battery accommodating case 23, and the driven pulley 522 of the right connection terminal displacement mechanism 50 is provided on the right outer side of the right battery accommodating case 23. Accordingly, the driven pulley 522 can be disposed in a space between an end of the battery accommodating case 23 in the left-right direction and the body cover 22, and an increase in size of the battery storage device 10 can be prevented.

The transmission belt 523 is formed of an elastic member such as rubber.

In the deceleration device 52 configured as described above, the drive pulley 521 pivots integrally with the hinge shaft 32 by the opening and closing operation of the opening and closing unit 30, and the driven pulley 522 pivots via the transmission belt 523. At this time, since the driven pulley 522 is the pulley having the larger diameter than the drive pulley 521, a pivot speed of the driven pulley 522 is lower than a pivot speed of the drive pulley 521, that is, a pivot speed of the opening and closing unit 30 during the opening and closing operation. In this way, the deceleration device 52 can decelerate the pivot of the opening and closing unit 30 and output rotational power from the driven pulley 522, and can set a speed of connecting the case-side connection terminal unit 40 to the battery-side connection terminal unit 90 low, and thus a mutual abrasion due to contact between the battery-side connection terminal unit 90 and the case-side connection terminal unit 40 can be prevented.

The link mechanism 51 includes a pair of left and right link plates 511 and a coupling member 512 that couples the pair of left and right link plates 511.

The pair of left and right link plates 511 are disposed on the left outer side and the right outer side of each battery accommodating case 23 and extend in the up-down direction. An upper end of the left side 421b of the frame member 421 of the case-side connection terminal unit 40 is rotatably supported by a lower end of the left link plate 511, and an upper end of the right side 421b of the frame member 421 of the case-side connection terminal unit 40 is rotatably supported by a lower end of the right link plate 511. In the present embodiment, an upper region of the pair of left and right link plates 511 extends in the up-down direction behind the battery accommodating case 23 from an upper side toward a lower side as viewed in the left-right direction, the left and right link plates 511 are bent forward from a lower end of the upper region, and then a lower region extends in the up-down direction over the left side 421b of the frame member 421 of the case-side connection terminal unit 40 as viewed in the left-right direction.

The coupling member 512 includes a cross member 512a extending in the left-right direction and a pair of left and right lever portions 512b extending in a substantially orthogonal direction from both left and right ends of the cross member 512a.

An upper end of the left link plate 511 is rotatably supported by a left end of the cross member 512a, and an upper end of the right link plate 511 is rotatably supported by a right end of the cross member 512a.

One of the pair of left and right lever portions 512b is coupled to the driven pulley shaft 522a rotatably supported on the main body frame 21 of the body unit 20, and the other lever portion 512b is rotatably supported on a pivotally support member 512c such as a bolt or a pin fixed to the main body frame 21 of the body unit 20. An axis of the pivotally support member 512c is provided in a manner of being coaxial with a pivot axis of the driven pulley shaft 522a.

Therefore, when the driven pulley 522 pivots, the coupling member 512 pivots integrally with the driven pulley 522. At this time, as described above, since the driven pulley 522 is the pulley having the larger diameter than the drive pulley 521, the pivot speed of the driven pulley 522, that is, a pivot speed of the coupling member 512 is lower than the pivot speed of the drive pulley 521, that is, the pivot speed of the opening and closing unit 30 during the opening and closing operation. In this way, the pivot due to the opening and closing operation of the opening and closing unit 30 is decelerated by the deceleration device 52 and transmitted from the coupling member 512 to the pair of left and right link plates 511. Further, the pair of left and right link plates 511 are displaced in the up-down direction by the pivot of the coupling member 512. Accordingly, the case-side connection terminal unit 40 in which the upper ends of the pair of left and right sides 421b of the frame member 421 are supported by the lower ends of the pair of left and right link plates 511 is displaced in the up-down direction together with the pair of left and right link plates 511.

The coupling member 512 of the connection terminal displacement mechanism 50 is provided such that the lever portion 512b extends rearward from the axis of the pivotally support member 512c and the pivot axis of the driven pulley shaft 522a when the opening and closing unit 30 is at the fully open position. Therefore, when the opening and closing unit 30 is at the fully open position, the cross member 512a of the coupling member 512 of the connection terminal displacement mechanism 50 extends in the left-right direction behind the axis of the pivotally support member 512c and the pivot axis of the driven pulley shaft 522a.

The coupling member 512 of the connection terminal displacement mechanism 50 is provided such that the lever portion 512b extends rearward from the axis of the pivotally support member 512c and the pivot axis of the driven pulley shaft 522a when the opening and closing unit 30 is at the fully closed position. Therefore, when the opening and closing unit 30 is at the fully closed position, the cross member 512a of the coupling member 512 of the connection terminal displacement mechanism 50 extends in the left-right direction behind the axis of the pivotally support member 512c and the pivot axis of the driven pulley shaft 522a.

(Buckle Unit)

As shown in FIGS. 1 to 4, the buckle unit 60 is pivotally supported by the main body frame 21 at the front end of the body unit 20 such that the pivot axis extends in the left-right direction. One buckle unit 60 is provided for each opening and closing unit 30. In the present embodiment, two opening and closing units 30 are provided side by side in the left-right direction, and two buckle units 60 are also provided side by side in the left-right direction.

The buckle unit 60 includes a buckle arm portion 61 that is pivotally supported by the body frame 21 such that a pivot axis extends in the left-right direction and extends from the pivot axis in a direction orthogonal to a pivot axis direction, and a buckle lever portion 62 in which a base end is connected to a tip end of the buckle arm portion 61 and extends in a direction orthogonal to the pivot axis direction of the buckle arm portion 61. The tip end of the buckle arm portion 61 and the base end of the buckle lever portion 62 are pivotally coupled to each other such that a pivot axis extends in the left-right direction.

After the opening and closing unit 30 is closed and pivoted from the fully open position shown in FIG. 3 to the fully closed position shown in FIG. 4, the buckle unit 60 is pivoted counterclockwise as viewed from the leftward direction. Thus, as shown in FIG. 4, the buckle arm portion 61 extends upward from the pivot axis of the buckle arm portion 61 along a front surface of the top cover 34 of the opening and closing unit 30. The buckle lever portion 62 further pivots counterclockwise with respect to the buckle arm portion 61 as viewed from the leftward direction, and extends rearward from the front end of the upper surface of the top cover 34 of the opening and closing unit 30 along an upper surface of the top cover 34 of the opening and closing unit 30.

The opening and closing unit 30 is provided with a locked portion 35 that is fixed to the cover frame 31 and is exposed from the upper surface of the top cover 34 of the opening and closing unit 30. Further, the buckle lever portion 62 is locked to the locked portion 35 of the opening and closing unit 30 in a state of extending rearward from the front end of the upper surface of the top cover 34 of the opening and closing unit 30 along the upper surface of the top cover 34 of the opening and closing unit 30. Therefore, the opening and closing unit 30 is locked at the fully closed position by the buckle unit 60, thereby preventing the opening and closing unit 30 from unintentionally opening from the fully closed position.

At this time, the plurality of buckle units 60 pivot in a direction orthogonal to an arrangement direction of the plurality of opening and closing units 30, that is, the left-right direction, and are arranged side by side in the arrangement direction of the plurality of opening and closing units 30. Therefore, when the plurality of opening and closing units 30 are arranged side by side, the buckle unit 60 is provided at an end of the opening and closing unit 30 in the direction orthogonal to the arrangement direction of the opening and closing units 30. Accordingly, the opening and closing unit 30 can be locked at the fully closed position without disposing the buckle unit 60 at the end of the opening and closing unit 30 in the arrangement direction of the opening and closing units 30, and thus the buckle unit 60 can be provided without increasing a dimension in the arrangement direction of the plurality of opening and closing units 30 in the battery storage device 10.

The buckle unit 60 locks the opening and closing unit 30 at the fully closed position with the buckle lever portion 62 extending along the upper surface of the top cover 34 of the opening and closing unit 30, and thus whether the opening and closing unit 30 is locked by the buckle unit 60 can be checked by simply looking at the upper surface of the top cover 34 when the opening and closing unit 30 is at the fully closed position in a state in which the battery storage device 10 is mounted on the external load or the like. Therefore, whether the opening and closing unit 30 is locked by the buckle unit 60 can be easily checked.

<Displacement Operation of Case-Side Connection Terminal Unit Due to Opening and Closing Operation of Opening and Closing Unit>

Next, a displacement operation of the case-side connection terminal unit 40 due to the opening and closing operation of the opening and closing unit 30 will be described with reference to FIGS. 3 and 4. In FIGS. 3 and 4, an operation of the connection terminal displacement mechanism 50L that displaces the left case-side connection terminal unit 40 in the up-down direction as the connection terminal displacement mechanism 50 will be described. An operation of the connection terminal displacement mechanism 50R that displaces the right case-side connection terminal unit 40 in the up-down direction is bilaterally symmetrical to that of the connection terminal displacement mechanism 50L, and thus a detailed description thereof will be omitted.

(Displacement Operation of Case-Side Connection Terminal Unit Due to Closing Operation of Opening and Closing Unit)

As shown in FIG. 3, when the opening and closing unit 30 is at the fully open position, the input plug 41 of the case-side connection terminal unit 40 is located at a retreat position P1. The retreat position P1 is a position where, in a state in which the battery 80 is accommodated in the battery accommodating portion 24 of the body unit 20 and the bottom surface 80D of the battery 80 abuts against the bottom wall 23D of the battery accommodating case 23, the pair of positive and negative input terminal pins 411, the plurality of signal terminal pins 412, and the pair of left and right guide pins 413 of the case-side connection terminal unit 40 are respectively separated from the output terminal sockets 91, signal terminal sockets 92, and guide holes 93 respectively paired therewith of the battery-side connection terminal unit 90, and the input plug 41 of the case-side connection terminal unit 40 is located below the bottom wall 23D of the battery accommodating case 23 (see FIG. 8A).

Further, when the opening and closing unit 30 is closed from the fully open position, the opening and closing unit 30 pivots forward with respect to the body unit 20 about the hinge shaft 32 as the pivot axis, that is, in the clockwise direction as viewed from the leftward direction.

When the hinge shaft 32 pivots in the clockwise direction as viewed from the leftward direction, the drive pulley 521 of the deceleration device 52 pivots clockwise together with the hinge shaft 32 as viewed from the leftward direction, and the driven pulley 522 also pivots clockwise by the transmission belt 523 as viewed from the leftward direction. Thus, the coupling member 512 pivots clockwise together with the driven pulley 522 as viewed from the leftward direction. When the opening and closing unit 30 is at the fully open position, the cross member 512a of the coupling member 512 of the connection terminal displacement mechanism 50 extends in the left-right direction behind the axis of the pivotally support member 512c and the pivot axis of the driven pulley shaft 522a, and thus the coupling member 512 is displaced upward when pivoted in the clockwise direction as viewed from the leftward direction. When the coupling member 512 pivots in the clockwise direction as viewed from the leftward direction and is displaced upward, the pair of left and right link plates 511 supported by the left and right ends of the cross member 512a of the coupling member 512 are displaced upward together with the coupling member 512. When the pair of left and right link plates 511 are displaced upward, the case-side connection terminal unit 40 in which the upper ends of the pair of left and right sides 421b of the frame member 421 are supported by the lower ends of the pair of left and right link plates 511 is displaced upward together with the pair of left and right link plates 511.

Thus, when the opening and closing unit 30 is closed, the case-side connection terminal unit 40 is displaced upward.

Further, when the opening and closing unit 30 reaches the fully closed position and is closed, the closing operation of the opening and closing unit 30 is completed. When the opening and closing unit 30 is at the fully closed position, the input plug 41 of the case-side connection terminal unit 40 is located at a connection position P2. The connection position P2 is a position where the pair of left and right input terminal pins 411 and the plurality of signal terminal pins 412 provided in the input plug 41 of the case-side connection terminal unit 40 are respectively fitted and connected to the output terminal sockets 91 and the signal terminal sockets 92 respectively paired therewith of the battery-side connection terminal unit 90, and the input plug 41 of the case-side connection terminal unit 40 is connected to the battery-side connection terminal unit 90. (See FIG. 8C and FIG. 8D).

When the input plug 41 of the case-side connection terminal unit 40 is at the connection position P2, the electric power stored in the battery 80 and output from the output terminal socket 91 of the battery-side connection terminal unit 90 passes through the input terminal pins 411, is raised or lowered by the above-described DC-DC converter of the electrical component 70, and is supplied to the external load, and the signals of various kinds of information indicating the state of the battery 80 and output from the signal terminal sockets 92 of the battery-side connection terminal unit 90 pass through the signal terminal pins 412 and are input to the above-described battery management system of the electrical component 70.

(Displacement Operation of Case-Side Connection Terminal Unit Due to Opening Operation of Opening and Closing Unit)

As shown in FIG. 4, when the opening and closing unit 30 is opened from the fully closed position, the opening and closing unit 30 pivots backward with respect to the body unit 20 around the hinge shaft 32 as the pivot axis, that is, in the counterclockwise direction as viewed from the leftward direction.

When the hinge shaft 32 pivots in the counterclockwise direction as viewed from the leftward direction, the drive pulley 521 of the deceleration device 52 pivots counterclockwise together with the hinge shaft 32 as viewed from the leftward direction, and the driven pulley 522 also pivots counterclockwise by the transmission belt 523 as viewed from the leftward direction. Thus, the coupling member 512 pivots counterclockwise together with the driven pulley 522 as viewed from the leftward direction. When the opening and closing unit 30 is at the fully closed position, the cross member 512a of the coupling member 512 of the connection terminal displacement mechanism 50 extends in the left-right direction behind the axis of the pivotally support member 512c and the pivot axis of the driven pulley shaft 522a, and thus the coupling member 512 is displaced downward when pivoted in the counterclockwise direction as viewed from the leftward direction. When the coupling member 512 pivots in the counterclockwise direction as viewed from the leftward direction and is displaced downward, the pair of left and right link plates 511 supported by the left and right ends of the cross member 512a of the coupling member 512 are displaced downward together with the coupling member 512. When the pair of left and right link plates 511 are displaced downward, the case-side connection terminal unit 40 in which the upper ends of the pair of left and right sides 421b of the frame member 421 are supported by the lower ends of the pair of left and right link plates 511 is displaced downward together with the pair of left and right link plates 511.

Thus, when the opening and closing unit 30 is opened, the case-side connection terminal unit 40 is displaced downward.

Further, when the opening and closing unit 30 reaches the fully open position and is opened, the opening operation of the opening and closing unit 30 is completed. As described above, when the opening and closing unit 30 is at the fully open position, the input plug 41 of the case-side connection terminal unit 40 is located at the retreat position P1.

In this way, the case-side connection terminal unit 40 is provided in a manner of being displaceable between the connection position P2 where the input plug 41 is connected to the battery-side connection terminal unit 90 and the retreat position P1 where the input plug 41 is separated from the battery-side connection terminal unit 90.

The connection terminal displacement mechanism 50 displaces the input plug 41 of the case-side connection terminal unit 40 between the connection position P2 and the retreat position P1 in conjunction with the opening and closing operation of the opening and closing unit 30. Further, the connection terminal displacement mechanism 50 displaces the input plug 41 of the case-side connection terminal unit 40 to the connection position P2 in conjunction with the closing operation of the opening and closing unit 30, and displaces the input plug 41 of the case-side connection terminal unit 40 to the retreat position P1 in conjunction with the opening operation of the opening and closing unit 30.

Thus, the input plug 41 of the case-side connection terminal unit 40 can be displaced between the connection position P2 and the retreat position P1 in conjunction with the opening and closing operation of the opening and closing unit 30, and thus a member such as a lever or a handle that displaces the input plug 41 of the case-side connection terminal unit 40 between the connection position P2 and the retreat position P1 is unnecessary. Accordingly, the number of components of the battery storage device 10 can be reduced. Further, the pair of left and right input terminal pins 411 and the plurality of signal terminal pins 412 provided in the input plug 41 of the case-side connection terminal unit 40 are displaced by the opening and closing operation of the opening and closing unit 30, and are respectively connected to the output terminal sockets 91 and signal terminal sockets 92 respectively paired therewith of the battery-side connection terminal unit 90, and thus there is no need to separately perform an operation for respectively connecting the pair of left and right input terminal pins 411 and the plurality of signal terminal pins 412 provided in the input plug 41 of the case-side connection terminal unit 40 to the output terminal sockets 91 and the signal terminal sockets 92 respectively paired therewith of the battery-side connection terminal unit 90, and operation man-hours for respectively connecting the pair of left and right input terminal pins 411 and the plurality of signal terminal pins 412 provided in the input plug 41 of the case-side connection terminal unit 40 to the output terminal sockets 91 and the signal terminal sockets 92 respectively paired therewith of the battery-side connection terminal unit 90 are reduced.

Since the input plug 41 of the case-side connection terminal unit 40 is displaced to the connection position P2 by the connection terminal displacement mechanism 50 in conjunction with the closing operation of the opening and closing unit 30, the pair of left and right input terminal pins 411 and the plurality of signal terminal pins 412 provided in the input plug 41 of the case-side connection terminal unit 40 are prevented from being respectively connected to the output terminal sockets 91 and the signal terminal sockets 92 respectively paired therewith of the battery-side connection terminal unit 90 while the opening and closing unit 30 is in the open state. Accordingly, it is possible to prevent the pair of left and right input terminal pins 411 and the plurality of signal terminal pins 412 provided in the input plug 41 of the case-side connection terminal unit 40 from being respectively connected to the output terminal sockets 91 and the signal terminal sockets 92 respectively paired therewith of the battery-side connection terminal unit 90 while the opening and closing unit 30 is in the open state, and to prevent a foreign matter from entering the battery accommodating portion 24, thereby preventing an occurrence of a short circuit or the like in the pair of left and right input terminal pins 411 and the plurality of signal terminal pins 412 provided in the input plug 41 of the case-side connection terminal unit 40, and the output terminal sockets 91 and the signal terminal sockets 92 respectively paired therewith of the battery-side connection terminal unit 90.

Since the input plug 41 of the case-side connection terminal unit 40 is displaced to the retreat position P1 by the connection terminal displacement mechanism 50 in conjunction with the opening operation of the opening and closing unit 30, it is possible to prevent the opening and closing unit 30 from being opened and the battery 80 from being removed from the battery accommodating portion 24 while the pair of left and right input terminal pins 411 and the plurality of signal terminal pins 412 provided in the input plug 41 of the case-side connection terminal unit 40 are respectively connected to the output terminal sockets 91 and the signal terminal sockets 92 respectively paired therewith of the battery-side connection terminal unit 90. Accordingly, it is possible to prevent the opening and closing unit 30 being opened and the battery 80 from being removed from the battery accommodating portion 24 while the pair of left and right input terminal pins 411 and the plurality of signal terminal pins 412 provided in the input plug 41 of the case-side connection terminal unit 40 are respectively connected to the output terminal sockets 91 and the signal terminal sockets 92 respectively paired therewith of the battery-side connection terminal unit 90, thereby preventing the pair of left and right input terminal pins 411 and the plurality of signal terminal pins 412 provided in the input plug 41 of the case-side connection terminal unit 40, and the output terminal sockets 91 and the signal terminal sockets 92 respectively paired therewith of the battery-side connection terminal unit 90 from being damaged.

<Positional Relationship Between Opening and Closing Unit and Input Plug>

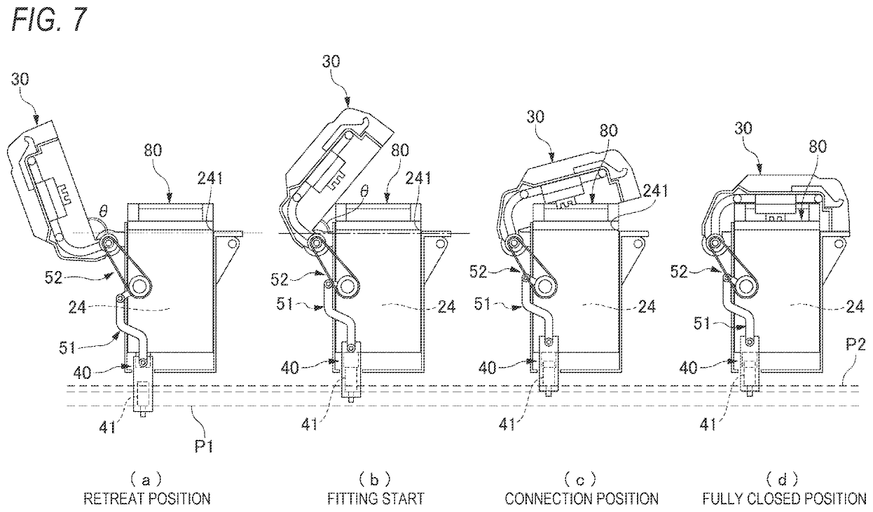

Next, a positional relationship between the opening and closing unit 30 and the input plug 41 during the displacement operation of the case-side connection terminal unit 40 will be described with reference to FIGS. 7 and 8A to 8D.

(Retreat Position)

As shown in part (a) of FIG. 7 and FIG. 8A, when the opening and closing unit 30 is located at the fully open position, the input plug 41 of the case-side connection terminal unit 40 is located at the retreat position P1. The retreat position P1 is a position where, in a state in which the battery 80 is accommodated in the battery accommodating portion 24 of the body unit 20 and the bottom surface 80D of the battery 80 abuts against the bottom wall 23D of the battery accommodating case 23, the pair of positive and negative input terminal pins 411, the plurality of signal terminal pins 412, and the pair of left and right guide pins 413 of the case-side connection terminal unit 40 are respectively separated from the output terminal sockets 91, signal terminal sockets 92, and guide holes 93 respectively paired therewith of the battery-side connection terminal unit 90, and the input plug 41 of the case-side connection terminal unit 40 is located below the bottom wall 23D of the battery accommodating case 23.

(Fitting Start)

As shown in part (b) of FIG. 7 and FIG. 8B, when the closing operation of the opening and closing unit 30 proceeds and the case-side connection terminal unit 40 is displaced upward, the pair of left and right guide pins 413 provided in the input plug 41 of the case-side connection terminal unit 40 are firstly fitted into the guide holes 93 respectively paired therewith of the battery-side connection terminal unit 90. Accordingly, the input plug 41 of the case-side connection terminal unit 40 and the battery-side connection terminal unit 90 are positioned.

At this time, the opening and closing unit 30 is provided at a position where at least a part thereof overlaps with the insertion and removal opening 241 of the battery accommodating portion 24 as viewed from the upward direction.

Further, when the closing operation of the opening and closing unit 30 further proceeds and the upward displacement of the case-side connection terminal unit 40 proceeds, the pair of input terminal pins 411 and the plurality of signal terminal pins 412 provided in the input plug 41 of the case-side connection terminal unit 40 start to be respectively fitted and connected to the output terminal sockets 91 and signal terminal sockets 92 respectively paired therewith of the battery-side connection terminal unit 90.

At this time, the input plug 41 of the case-side connection terminal unit 40 is displaced upward in a state in which the pair of left and right guide pins 413 are fitted into the guide holes 93 of the battery-side connection terminal unit 90, so that the pair of left and right input terminal pins 411 and the plurality of signal terminal pins 412 provided in the input plug 41 of the case-side connection terminal unit 40 can be respectively fitted and connected to the output terminal sockets 91 and the signal terminal sockets 92 respectively paired therewith of the battery-side connection terminal unit 90 without being displaced. Accordingly, it is possible to prevent the pair of left and right input terminal pins 411 and the plurality of signal terminal pins 412 provided in the input plug 41 of the case-side connection terminal unit 40 and the output terminal sockets 91 and the signal terminal sockets 92 respectively paired therewith of the battery-side connection terminal unit 90 from being damaged.

Further, in a state in which at least a part of the pair of input terminal pins 411 and the plurality of signal terminal pins 412 provided in the input plug 41 of the case-side connection terminal unit 40 are respectively connected to the output terminal sockets 91 and the signal terminal sockets 92 respectively paired therewith of the battery-side connection terminal unit 90 (a state in which the opening and closing unit 30 transitions from part (b) of FIG. 7 and FIG. 8B to part (c) of FIG. 7 and FIG. 8C), the opening and closing unit 30 is provided at the position where at least a part thereof overlaps with the insertion and removal opening 241 of the battery accommodating portion 24 as viewed from the upward direction. Therefore, when at least a part of the pair of input terminal pins 411 and the plurality of signal terminal pins 412 provided in the input plug 41 of the case-side connection terminal unit 40 are respectively connected to the output terminal sockets 91 and the signal terminal sockets 92 respectively paired therewith of the battery-side connection terminal unit 90, the opening and closing unit 30 covers at least a part of the insertion and removal opening 241 of the battery accommodating portion 24, and thus the opening and closing unit 30 prevents the battery 80 from being removed from the insertion and removal opening 241. Accordingly, when at least a part of the pair of input terminal pins 411 and the plurality of signal terminal pins 412 provided in the input plug 41 of the case-side connection terminal unit 40 are respectively connected to the output terminal sockets 91 and the signal terminal sockets 92 respectively paired therewith of the battery-side connection terminal unit 90, the battery 80 is prevented from being removed from the battery accommodating portion 24, and thus the pair of input terminal pins 411 and the plurality of signal terminal pins 412 provided in the input plug 41 of the case-side connection terminal unit 40 can be prevented from being damaged.

(Connection Position)

As shown in part (c) of FIG. 7 and FIG. 8C, when the closing operation of the opening and closing unit 30 further proceeds and the upward displacement of the case-side connection terminal unit 40 further proceeds, the input plug 41 of the case-side connection terminal unit 40 is displaced to the connection position P2. Further, the pair of left and right input terminal pins 411 and the plurality of signal terminal pins 412 provided in the input plug 41 of the case-side connection terminal unit 40 are respectively fitted and connected to the output terminal sockets 91 and the signal terminal sockets 92 respectively paired therewith of the battery-side connection terminal unit 90.

(Fully Closed Position)

As illustrated in part (d) of FIG. 7 and FIG. 8D, when the closing operation of the opening and closing unit 30 further proceeds, the frame member 421 and the coupling pin 422 of the plug holder 42 are further displaced upward, and the opening and closing unit 30 is at the fully closed position. At this time, the stopper plate 423b of the spring unit 423 is displaced upward together with the coupling pin 422, but the coil spring 423c of the spring unit 423 is compressed without displacing the input plug 41 from the connection position P2. Further, when the opening and closing unit 30 is in the fully closed state, the input plug 41 is held at the connection position P2 in a state of being biased toward the battery-side connection terminal unit 90 of the battery 80 by the compressed coil spring 423c.

Accordingly, when the opening and closing unit 30 is at the fully closed position, even when the battery 80 accommodated in the battery accommodating portion 24 vibrates in the up-down direction, the input plug 41 of the case-side connection terminal unit 40 can be displaced following the vibration of the battery-side connection terminal unit 90 of the battery 80 in the up-down direction by biasing force of the compressed coil spring 423c. Accordingly, even when the battery 80 accommodated in the battery accommodating portion 24 vibrates in the up-down direction, it is possible to maintain the fitting and connection between the pair of input terminal pins 411 and the plurality of signal terminal pins 412 provided in the input plug 41 of the case-side connection terminal unit 40 and the output terminal sockets 91 and the signal terminal sockets 92 respectively paired therewith the battery-side connection terminal unit 90.

The opening and closing unit 30 is configured to pivot to the fully open position when an opening angle θ with respect to an opening plane of the insertion and removal opening 241 of the battery accommodating portion 24 is equal to or greater than a predetermined angle, and pivot to the fully closed position when the opening angle θ is less than the predetermined angle, as viewed from the leftward direction. In the present embodiment, the opening angle θ is, as viewed from the leftward direction, an angle formed by the opening plane of the insertion and removal opening 241 of the battery accommodating portion 24 and a plane formed by a lower end of the top cover 34 that constitutes the outer shell of the opening and closing unit 30 and seals the battery accommodating portion 24. The predetermined angle is, for example, 90 degrees.

The opening and closing unit 30 may be configured to pivot to the fully open position when the opening angle θ is equal to or greater than the predetermined angle and pivot to the fully closed position when the opening angle θ is less than the predetermined angle due to a weight of the opening and closing unit 30. Further, a biasing unit (not shown) coupled to the opening and closing unit 30 and the body unit 20 may be provided, and the opening and closing unit 30 may be biased by the biasing unit so as to pivot to the fully open position when the opening angle θ is equal to or greater than the predetermined angle and pivot to the fully closed position when the opening angle θ is less than the predetermined angle.

Therefore, the opening and closing unit 30 is held at either the fully open position or the fully closed position when the user or the like does not perform the opening and closing operation. Accordingly, it is possible to prevent an occurrence of chattering in which when the user or the like does not open or close the opening and closing unit 30, the opening and closing unit 30 pivots in a manner of vibrating in an opening direction and a closing direction in the vicinity of a position at which the pair of input terminal pins 411 and the plurality of signal terminal pins 412 provided in the input plug 41 of the case-side connection terminal unit 40 start to be respectively fitted and connected to the output terminal sockets 91 and the signal terminal sockets 92 respectively paired therewith of the battery-side connection terminal unit 90, and the pair of input terminal pins 411 and the plurality of signal terminal pins 412 provided in the input plug 41 of the case-side connection terminal unit 40, and the output terminal sockets 91 and the signal terminal sockets 92 respectively paired therewith of the battery-side connection terminal unit 90 are repeatedly connected and separated in a short period of time.

Further, since the opening and closing unit 30 is held at either the fully open position or the fully closed position, it is possible to prevent the opening and closing unit 30 from stopping at a position before reaching the fully closed position when the user or the like closes the opening and closing unit 30. Therefore, it is possible to prevent the battery-side connection terminal unit 90 and the case-side connection terminal unit 40 from being in an incompletely fitted and connected state, and thus to prevent the external load from being activated in the incompletely fitted and connected state.

Furthermore, since the opening and closing unit 30 is held at either the fully open position or the fully closed position, it is possible to prevent the opening and closing unit 30 from stopping at a position before reaching the fully closed position when the user or the like closes the opening and closing unit 30. Therefore, it is possible to prevent the rain, the dust, and the like from entering the battery accommodating portion 24 from the outside.

In the battery storage device 10 configured as described above, the connection terminal displacement mechanism 50 includes the deceleration device 52 that decelerates the pivot of the hinge shaft 32 and transmits the pivot to the link mechanism 51, so that the pair of left and right input terminal pins 411 and the plurality of signal terminal pins 412 provided in the input plug 41 of the case-side connection terminal unit 40 can be respectively fitted and connected to the output terminal sockets 91 and the signal terminal sockets 92 respectively paired therewith of the battery-side connection terminal unit 90 at a speed lower than the pivot speed of the opening and closing unit 30. Accordingly, when the pair of left and right input terminal pins 411 and the plurality of signal terminal pins 412 provided in the input plug 41 of the case-side connection terminal unit 40 can be respectively fitted and connected to the output terminal sockets 91 and the signal terminal sockets 92 respectively paired therewith of the battery-side connection terminal unit 90, it is possible to prevent the pair of left and right input terminal pins 411 and the plurality of signal terminal pins 412 provided in the input plug 41 of the case-side connection terminal unit 40 and the output terminal sockets 91 and the signal terminal sockets 92 respectively paired therewith of the battery-side connection terminal unit 90 from being damaged.

The deceleration device 52 includes the drive pulley 521 that pivots integrally with the hinge shaft 32, the driven pulley 522 coupled to the link mechanism 51, and the transmission belt 523 wound around the drive pulley 521 and the driven pulley 522, and thus a reduction ratio can be easily adjusted by adjusting the diameters of the drive pulley 521 and the driven pulley 522. Accordingly, a speed at which the pair of left and right input terminal pins 411 and the plurality of signal terminal pins 412 provided in the input plug 41 of the case-side connection terminal unit 40 can be respectively fitted and connected to the output terminal sockets 91 and the signal terminal sockets 92 respectively paired therewith of the battery-side connection terminal unit 90 can be easily set to an appropriate speed.

Further, since the transmission belt 523 is formed of the elastic member such as rubber, even in a case in which the input plug 41 of the case-side connection terminal unit 40 collides with an obstacle or the like when the input plug 41 is displaced upward and the upward displacement is prevented, a load applied to the pair of left and right input terminal pins 411 and the plurality of signal terminal pins 412 provided in the input plug 41 of the case-side connection terminal unit 40 can be reduced by elastic deformation of the transmission belt 523.

Although an embodiment of the present invention has been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, respective constituent elements in the above embodiments may be freely combined without departing from the gist of the invention.

For example, in the present embodiment, the battery-side connection terminal unit 90 includes the pair of positive and negative output terminal sockets 91 for outputting the electric power stored in the battery 80 and the plurality of signal terminal sockets 92 for outputting the signals of various types of information indicating the state of the battery 80, and the case-side connection terminal unit 40 includes the pair of plus and minus input terminal pins 411 and the signal terminal pins 412, but output terminals and signal terminals of the battery-side connection terminal unit 90 may have a pin shape, and input terminals and signal terminals of the case-side connection terminal unit 40 may have a socket shape.

Further, for example, at least one of the buckle lever portion 62 of the buckle unit 60 and the locked portion 35 of the opening and closing unit 30 may be provided with a sensor, and it may be possible to detect whether the buckle lever portion 62 of the buckle unit 60 is locked to the locked portion 35 of the opening and closing unit 30. At this time, the sensor may output, to the above-described battery management system of the electrical component 70, a signal indicating whether the buckle lever portion 62 of the buckle unit 60 is locked to the locked portion 35 of the opening and closing unit 30.

In the present specification, at least the following matters are described. In the parentheses, the corresponding constituent elements and the like in the above embodiments are shown as an example, but the present invention is not limited thereto.

(1) A battery storage device (battery storage device 10) including:
a body (body unit 20) including a battery accommodating portion (battery accommodating portion 24) provided with an insertion and removal opening (insertion and removal opening 241) opened in a first direction (upward direction);
an opening and closing portion (opening and closing unit 30) provided in a manner of being openable and closable with respect to the body so as to open and close the insertion and removal opening; and
a case-side connection terminal (input terminal pin 411), in which
a battery (battery 80) including a battery-side connection terminal (output terminal socket 91) is accommodated so as to be insertable and removal in the battery accommodating portion through the insertion and removal opening,
the case-side connection terminal is provided in a manner of being displaceable between a connection position (connection position P2) where the case-side connection terminal is connected to the battery-side connection terminal and a retreat position (retreat position P1) where the case-side connection terminal is separated from the battery-side connection terminal,
the battery storage device further includes a connection terminal displacement mechanism (connection terminal displacement mechanism 50) configured to displace the case-side connection terminal between the connection position and the retreat position, and
the connection terminal displacement mechanism displaces the case-side connection terminal in conjunction with an opening and closing operation of the opening and closing portion.

According to (1), since the case-side connection terminal can be displaced between the connection position and the retreat position in conjunction with the opening and closing operation of the opening and closing portion, the member such as a lever or a handle that displaces the case-side connection terminal between the connection position and the retreat position becomes unnecessary. Accordingly, the number of components of the battery storage device can be reduced. Furthermore, since the case-side connection terminal is displaced and connected to the battery terminal by the opening and closing operation of the opening and closing portion, it is not necessary to separately perform the operation for connecting the case-side connection terminal to the battery-side terminal, and the operation man-hours for connecting the case-side connection terminal to the battery-side terminal can be reduced.

(2) The battery storage device according to (1), in which
the connection terminal displacement mechanism displaces the case-side connection terminal to the connection position in conjunction with a closing operation of the opening and closing portion.

According to (2), the case-side connection terminal is displaced to the connection position in conjunction with the closing operation of the opening and closing portion by the connection terminal displacement mechanism, and thus the case-side connection terminal is prevented from being connected to the battery-side connection terminal while the opening and closing portion is in the open state. Accordingly, it is possible to prevent the occurrence of the short circuit or the like between the case-side connection terminal and the battery-side connection terminal due to the case-side connection terminal being connected to the battery-side connection terminal while the opening and closing portion is in the open state and the foreign matter entering the battery accommodating portion.

(3) The battery storage device according to (1) or (2), in which
the connection terminal displacement mechanism displaces the case-side connection terminal to the retreat position in conjunction with an opening operation of the opening and closing portion.

According to (3), the case-side connection terminal is displaced to the retreat position in conjunction with the opening operation of the opening and closing portion by the connection terminal displacement mechanism, so that it is possible to prevent the battery from being removed from the battery accommodating portion due to the opening and closing portion being opened while the case-side connection terminal is connected to the battery-side connection terminal. Accordingly, it is possible to prevent the case-side connection terminal from being damaged due to the opening and closing portion being opened while the case-side connection terminal is connected to the battery-side connection terminal and the battery being removed from the battery accommodating portion.

(4) The battery storage device according to any one of (1) to (3), in which
in a state in which at least a part of the case-side connection terminal is connected to the battery-side connection terminal, the opening and closing portion is provided at a position where at least a part thereof overlaps with the insertion and removal opening as viewed from the first direction.

According to (4), when at least a part of the case-side connection terminal is connected to the battery-side connection terminal, the opening and closing portion covers at least a part of the insertion and removal opening of the battery accommodating portion, and therefore the opening and closing portion prevents the battery from being removed from the insertion and removal opening. Accordingly, the battery is prevented from being removed from the battery accommodating portion in the state in which the case-side connection terminal is connected to the battery-side connection terminal, and thus the case-side connection terminal and the battery-side terminal can be prevented from being damaged.

(5) The battery storage device according to any one of (1) to (4), in which
the opening and closing operation of the opening and closing portion is performed by rotating the opening and closing portion with respect to the body about a pivot shaft (hinge shaft 32) rotatably supported by the body as a pivot axis, and
the connection terminal displacement mechanism includes
   a link mechanism (link mechanism 51) configured to displace the case-side connection terminal, and
   a deceleration device (deceleration device 52) configured to decelerate a rotation of the pivot shaft and transmit the rotation to the link mechanism.

According to (5), the connection terminal displacement mechanism can connect the case-side connection terminal to the battery-side connection terminal at a speed lower than a rotational speed of the opening and closing portion since the connection terminal displacement mechanism includes the deceleration device that decelerates the rotation of the pivot shaft and transmit the rotation to the link mechanism. Accordingly, when the case-side connection terminal is connected to the battery-side connection terminal, the damage to the case-side connection terminal and the battery-side connection terminal can be prevented.

(6) The battery storage device according to (5), in which
the deceleration device includes
   a drive pulley (drive pulley 521) that rotates integrally with the pivot shaft,
   a driven pulley (driven pulley 522) that is coupled to the link mechanism, and
   a transmission belt (transmission belt 523) that is wound around the drive pulley and the driven pulley.

According to (6), the deceleration device includes the drive pulley that rotates integrally with the pivot shaft, the driven pulley coupled to the link mechanism, and the transmission belt wound around the drive pulley and the driven pulley, and thus the reduction ratio can be easily adjusted by adjusting the diameters of the drive pulley and the driven pulley. Accordingly, the speed at which the case-side connection terminal is connected to the battery-side connection terminal can be easily set to the appropriate speed.

(7) The battery storage device according to (6), in which
the transmission belt is formed of an elastic member.

According to (7), since the transmission belt is formed by the elastic member, even in the case in which the case-side connection terminal collides with the obstacle or the like when the case-side connection terminal is displaced upward and the upward displacement is prevented, the load applied to the case-side connection terminal can be reduced by the elastic deformation of the transmission belt.

(8) The battery storage device according to any one of (5) to (7), in which
as viewed from an axial direction (left-right direction) of the pivot shaft, the opening and closing portion is configured to rotate to a fully open position when an opening angle (opening angle θ) with respect to an opening plane of the insertion and removal opening is equal to or greater than a predetermined angle and to rotate to a fully closed position when the opening angle is less than the predetermined angle.

According to (8), the opening and closing portion is held at either the fully open position or the fully closed position when the user or the like does not perform the opening and closing operation. Accordingly, it is possible to prevent an occurrence of chattering in which when the user or the like does not open and close the opening and closing portion, the opening and closing portion pivots in a manner of vibrating in an opening direction and a closing direction in the vicinity of a position where the case-side connection terminal starts to be connected to the battery-side connection terminal, and the case-side connection terminal and the battery-side connection terminal are repeatedly connected and separated in a short time.

### REFERENCE SIGNS LIST

10 battery storage device
20 body unit (body)
24 battery accommodating portion
241 insertion and removal opening
30 opening and closing unit (opening and closing portion)
32 hinge shaft (pivot shaft)
411 input terminal pin (case-side connection terminal)
50 connection terminal displacement mechanism
51 link mechanism
52 deceleration device
521 drive pulley
522 driven pulley
523 transmission belt
80 battery
91 output terminal socket (battery-side connection terminal)
P1 retreat position
P2 connection position
θ opening angle

1. A battery storage device comprising:
a body including a battery accommodating portion provided with an insertion and removal opening opened in a first direction;
an opening and closing portion provided in a manner of being openable and closable with respect to the body so as to open and close the insertion and removal opening; and
a case-side connection terminal, wherein
a battery including a battery-side connection terminal is accommodated so as to be insertable and removal in the battery accommodating portion through the insertion and removal opening,
the case-side connection terminal is provided in a manner of being displaceable between a connection position where the case-side connection terminal is connected to the battery-side connection terminal and a retreat position where the case-side connection terminal is separated from the battery-side connection terminal,
the battery storage device further comprises a connection terminal displacement mechanism configured to displace the case-side connection terminal between the connection position and the retreat position, and
the connection terminal displacement mechanism displaces the case-side connection terminal in conjunction with an opening and closing operation of the opening and closing portion.

2. The battery storage device according to claim 1, wherein
the connection terminal displacement mechanism displaces the case-side connection terminal to the connection position in conjunction with a closing operation of the opening and closing portion.

3. The battery storage device according to claim 1, wherein
the connection terminal displacement mechanism displaces the case-side connection terminal to the retreat position in conjunction with an opening operation of the opening and closing portion.

4. The battery storage device according to claim 1, wherein
in a state in which at least a part of the case-side connection terminal is connected to the battery-side connection terminal, the opening and closing portion is provided at a position where at least a part thereof overlaps with the insertion and removal opening as viewed from the first direction.

5. The battery storage device according to claim 1, wherein
the opening and closing operation of the opening and closing portion is performed by rotating the opening and closing portion with respect to the body about a pivot shaft rotatably supported by the body as a pivot axis, and
the connection terminal displacement mechanism includes
a link mechanism configured to displace the case-side connection terminal, and
a deceleration device configured to decelerate a rotation of the pivot shaft and transmit the rotation to the link mechanism.

6. The battery storage device according to claim 5, wherein
the deceleration device includes
a drive pulley that rotates integrally with the pivot shaft,
a driven pulley that is coupled to the link mechanism, and
a transmission belt that is wound around the drive pulley and the driven pulley.

7. The battery storage device according to claim 6, wherein
the transmission belt is formed of an elastic member.

8. The battery storage device according to claim 5, wherein
as viewed from an axial direction of the pivot shaft, the opening and closing portion is configured to rotate to a fully open position when an opening angle with respect to an opening plane of the insertion and removal opening is equal to or greater than a predetermined angle and to rotate to a fully closed position when the opening angle is less than the predetermined angle.
